(19) United States
(12) Patent Application Publication
(10) Pub. No.: US 2021/0217070 A1
(43) Pub. Date: Jul. 15, 2021

(54) Virtual Shopping Assistant

(71) Applicant: American Greetings Corporation, Cleveland, OH (US)

(72) Inventors: Todd Fraser, North Ridgeville, OH (US); Adam Margolin, Avon Lake, OH (US); Mary McClain, Shaker Heights, OH (US); Chadrick Anderson, Shaker Heights, OH (US)

(21) Appl. No.: 17/144,546

(22) Filed: Jan. 8, 2021

Related U.S. Application Data
(60) Provisional application No. 62/959,368, filed on Jan. 10, 2020.

(51) Int. Cl. G06Q 30/06; G06T 19/00

(52) U.S. Cl. CPC G06Q 30/0627; G06Q 30/0643; G06T 19/003; G06Q 30/0639; G06Q 30/0633; G06Q 30/0631

(57) ABSTRACT

A greeting card finder app tool which receives user input regarding an occasion and a greeting card recipient and also receives answers to one or more posed questions and returns to the user a list of appropriate or suitable greeting cards. Once a greeting card from the list is selected by the user, the app will provide the user with the location of where to find the selected card.

### RELATED APPLICATIONS

This application is a non-provisional of and claims priority to U.S. Provisional Patent Application No. 62/959,368, filed on Jan. 10, 2020, a copy of which is incorporated herein by reference in its entirety.

### FIELD OF THE INVENTION

This disclosure and related inventions is in the field of social expression products and services.

### SUMMARY OF THE INVENTION

In one embodiment, the present disclosure and related inventions are directed to a greeting card finder tool which includes a touch screen device located in a greeting card department of a retail store, a database containing a plurality of information regarding a plurality of greeting cards for sale at the retail store, where the touch screen engages a user in selecting a greeting card category and an intended recipient and also poses one or more questions to the user to infer the tone of the greeting card, and where after receiving the user's selections and answers to the one or more questions, the touch screen displays a list of appropriate greeting cards for the user to select, and where the touch screen also provides the user with the location of a user selected greeting card.

In another embodiment, the present disclosure and related inventions are directed to a process for finding a greeting card in the greeting card department of a retail store including the steps of: providing software that can interact with a user via a touch screen in a retail store; displaying a list of greeting card categories or occasions; receiving from the touch screen the user's selected category or occasion; displaying a list of recipient categories; receiving from the touch screen, the user's selected recipient; displaying one or more questions on the touch screen that will enable to software to more accurately display a list of appropriate greeting cards for the user; receiving, from the touch screen, the user's selected answers to the one or more questions; using a quantitative sorting process to determine a list of appropriate greeting cards for the user and displaying said list on the touch screen; receiving, from the touch screen, the user's selected greeting card; and using the greeting card stop keeping unit (SKU) to locate the card in the retail store and displaying the location to the user on the touch screen.

In still another embodiment, the present disclosure and related inventions are directed to a greeting card finder tool that includes software accessed by a touch screen on an in-store kiosk or a user's mobile device while in a retail store, a database containing a plurality of information about all greeting cards available for sale in the retail store at the time the user is engaging with the software, means for displaying output and receiving input from the user, via the touch screen, relating to, at least, the greeting card category, the greeting card recipient, the desired tone of the greeting card, and means to use the received user input to display, on the touch screen, a list of appropriate greeting cards, where the user may select, via the touchscreen, one of the greeting cards from the list, and where the touch screen will display the exact location at which the user may find the selected greeting card.

### DESCRIPTION OF THE DRAWINGS

FIG. 1 is a greeting card finder kiosk.

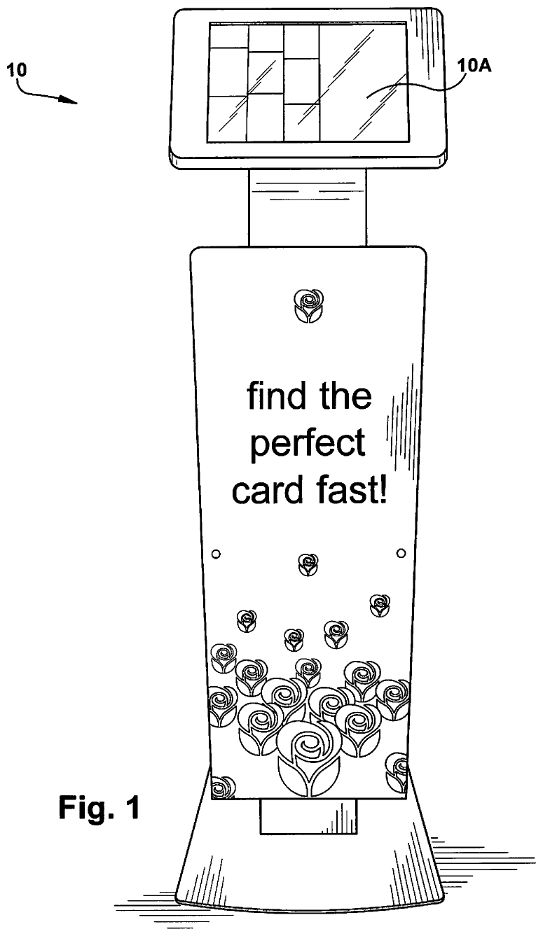

FIG. 2 is an example of the data exchange between a user device and greeting card finder tool.

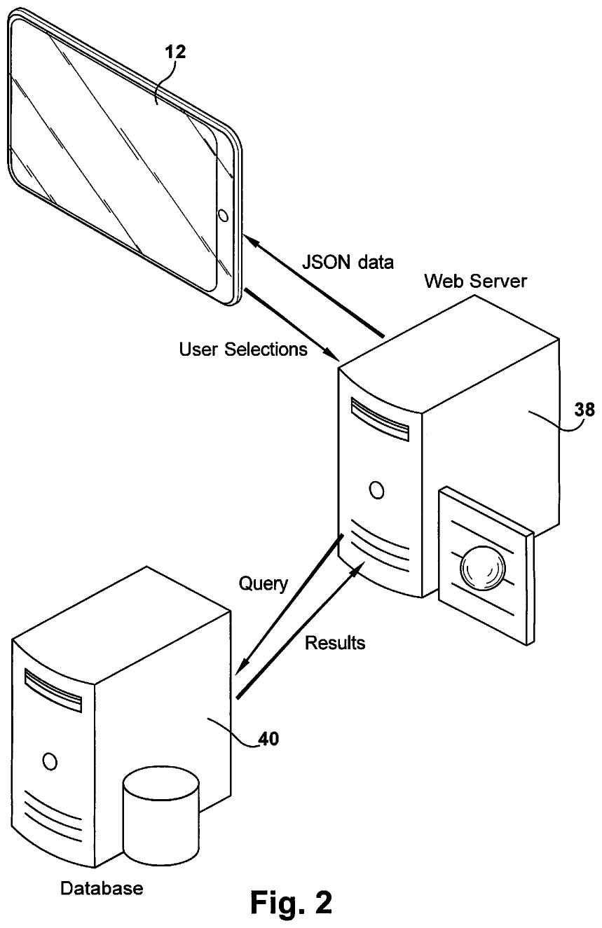

FIG. 3 is an example greeting card finder tool screen for describing a desired greeting card.

FIG. 4 is an example greeting card finder tool screen showing a recommended card list.

FIG. 5 is an example greeting card finder tool screen showing the card locator feature.

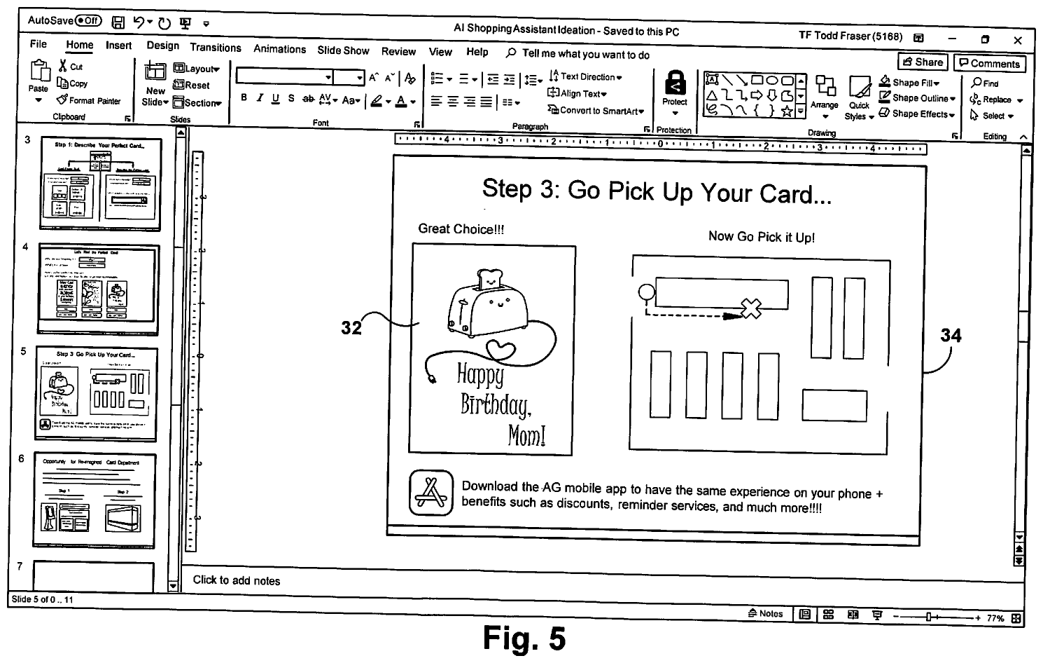

### DETAILED DESCRIPTION OF PREFERRED AND ALTERNATE EMBODIMENTS

The present disclosure and related inventions describe an interactive digital tool used to, among other things, assist users in the selection of one or more greeting cards in a greeting card department of a retail store.

The time and effort expended by consumers in searching for the perfect, or at least most appropriate, greeting card is, at times, a barrier to purchase. Consumers have busy lives and are sometimes pressed for time in which to run errands. Greeting card departments typically have a small amount of space in which to display as many card varieties as possible. This may result in the placement of potentially suitable cards in multiple locations. For consumers who have a limited amount of time in which to select a suitable greeting card, this task may seem daunting. Consumers do not want to simply select any card, but want to purchase the right card, given the intended recipient, the relationship he/she shares with the recipient and the occasion or event for which the greeting card is being purchased.

The present disclosure and related inventions seek to solve this problem by providing an interactive digital tool, located in the greeting card department of a retail store, which will quickly locate suitable greeting cards for consumers to purchase based on the input of a minimal amount of information. The tool allows for the rapid listing of recommended cards in manageable set along with precise location information. The tool may also remind users of important events and holidays and may provide the user with relevant coupons, offers and product information.

The greeting card finder tool is software-based and usable on a variety of digital devices, including, but not limited to, smart phone 12, tablet, personal computer, or other touch-screen hardware solutions. The tool may also be used in the form of a website or webpage. The application may be loaded on and permanently displayed at a kiosk 10 with a touch screen 10A in the greeting card department of a brick and mortar retail establishment. It can also be integrated into an existing shopping app owned by the retailer and used on consumer's mobile devices. Among other things, the greeting card finder tool includes one or more web servers 38 and databases (or other data storage device) 40 which contain information regarding all the greeting cards which are available in-store at the particular time the user is engaging with the greeting card finder tool. The disclosure and examples set forth below will be explained with respect to an in-store kiosk 10 but as noted above, the software may be on a user's mobile device 12, a website or part of the retailer's shopping app.

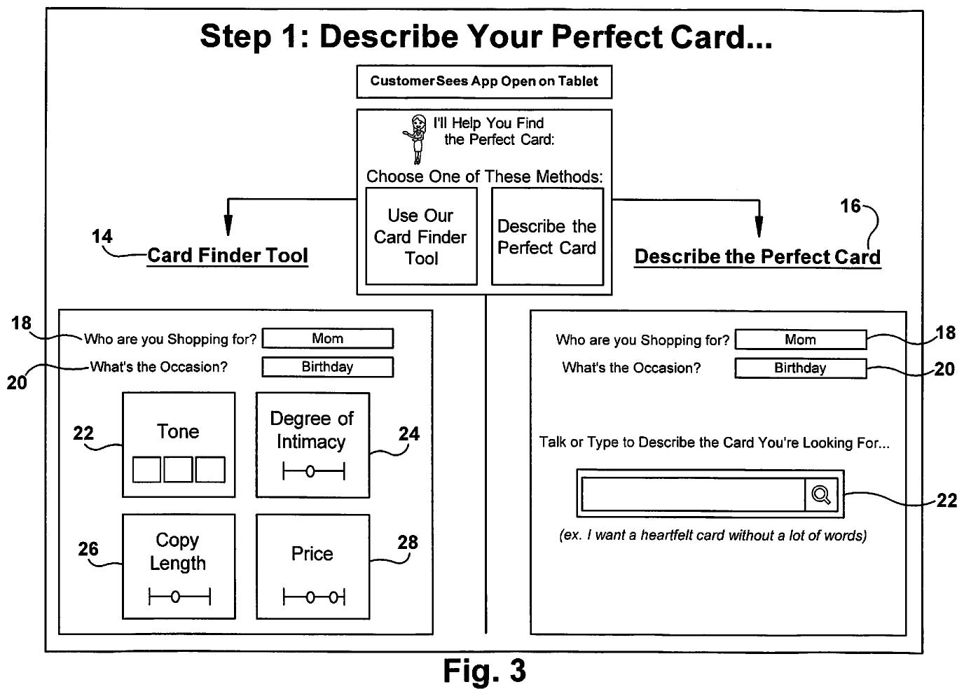

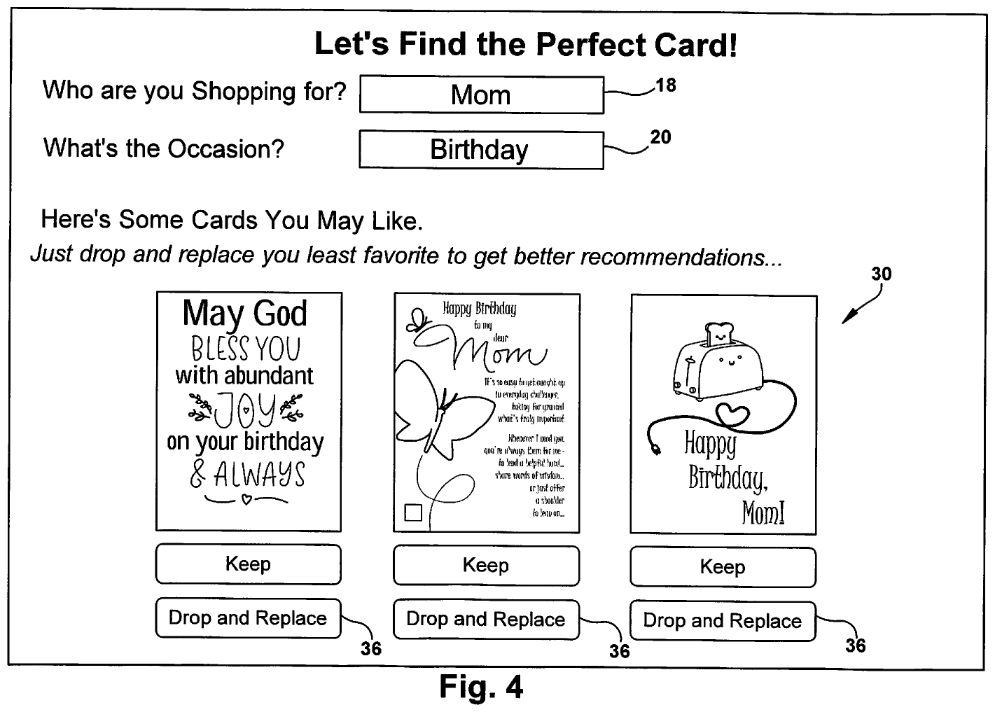

A consumer may begin a greeting card search by initiating interaction with the kiosk's touch screen 10A. In one embodiment, shown in FIG. 3, the user will be prompted to select between “using the card finder tool” 14 or “describing the perfect card” 16. If the user selects the “using the card finder tool” 14 option, he/she will be prompted to indicate his/her relationship to the card recipient 18 and select the occasion for the greeting card 20. The user may also be asked to select the tone of the greeting card 22, degree of intimacy with the recipient 24, the copy length 26 and greeting card price 28. The greeting card finder tool may also assist the user by offering interactive drop-downs or menu options to narrow the field of cards. This information is used in a quantitative sorting process to determine a list of greeting cards that are appropriate given the user's input. If the user selects the “describe the perfect card” option, he/she will be prompted to indicate his/her relationship to the card recipient 18 and select the occasion for the greeting card 20. The user may then enter, in natural language, the type of greeting card he/she is looking for 22. For example, the user may enter “I want a sentimental birthday card form my mom without a bunch of gushy words in it”. When using natural language as an input, a machine learning algorithm can match the user's preferences to all available greeting cards to determine a subgroup of all greeting cards (available in-store) which are most appropriate for the user (given the user's entered information). The “using the card finder tool” 14 and “describe the perfect card” 16 options each result in a list of “best matched” or “recommended” greeting cards 30, as shown, for example, in FIG. 4.

In another embodiment, the greeting card finder tool may be more visually driven, by providing different greeting card categories and occasions as selectable visual representations. The app begins by displaying a list of occasion categories, such as, for example, Birthday, Anniversary, New Baby, etc. Once the user selects a greeting card category, the app may then display a list of potential greeting card recipients, such as, for example, Mother, Wife, Daughter, etc. After the user selects a greeting card recipient, the app may then pose a series of questions to the user, such as, for example, “How close are you and the recipient?” or “How old is the recipient?” or other questions which allow the app to infer a proper tone for the greeting card. The user inputs/preferences are translated into data inputs for use in a quantitative sorting process. The quantitative sorting process uses the user input data to rank and ultimately display greeting card products to the user that closely match their preferences.

In both embodiments described above, if the user does not wish to purchase one of the greeting cards returned on the recommended or “best matched” greeting card list, he/she has the option to deselect a card that is the least like the greeting card they are looking for 36. The machine learning algorithm can drop this greeting card from the list and add a more relevant selection. This can be repeated until the user finds the desired greeting card.

Optionally, in either of the embodiments described above, the greeting card finder tool may also enable the user to add or upload additional information, imagery, text, and experiences to further inform the greeting card finder tool on the desired greeting card. The user can optionally upload an image of something they would like the greeting card to resemble by, for example, uploading a photo from a smart phone, etc. They can upload imagery or iconography that is an important element of the relationship between the user and greeting card recipient. This information can then be used by the greeting card finder tool to further enhance the quantitative process used to find the “recommended” or “best matched” list.

It is preferred that the “recommended” or “best matched” greeting card list 30 may be a small, manageable list of greeting card choices which best fit the occasion and recipient and that are available in-store. The user may view thumbnail views of the best card choices 30 and select each card to view the inside of the greeting card and read any printed sentiment (see FIG. 4). Once the user has decided and indicated to the app (selected through the touch screen) which card he/she would like to purchase 32, the tool will use the greeting card stock keeping unit (SKU) number (or other unique id) to look up the exact location of the greeting card within the retail environment. It will then display the location (aisle number, row, etc.) 34 to the user so that he/she can quickly locate the greeting card. This can also be done digitally by Augmented Reality or display lighting methods. The tool may also display a map of the greeting card department or entire retail store and indicate where to locate the desired greeting card 34. Also, computer-readable tags, such as, for example, RFID (including NFC), can be affixed to department shelving or other fixtures to aid in the navigation aspect of the invention.

As noted above, the greeting card finder tool may also be integrated into a retailer's proprietary shopping app. The app may receive and store special dates for each user and send card reminders when each date draws near. The user may receive push notifications upon entering the retail store for upcoming holidays or other saved events. The app may also provide the user with relevant coupons, helpful product or retailer information and may allow the user to earn rewards and points for entering the store, viewing an advertisement, purchasing a greeting card or other such task. The app can also send reminders to users to purchase greeting cards when perhaps they are browsing party goods or other seasonal merchandise on the retailer's shopping app. The app may additionally offer product information, coupons or other information based on the users use of the retailer's shopping app. These reminders and other information may be triggered by store geofencing.

Some additional features of the greeting card finder tool may include, but are not limited to, sharing influencer comments and/or ratings, sharing consumer comments and/or ratings, allowing users to connect with friends, or allowing users to select and order greeting cards online and pickup in-store.

In addition to the uses described above, the greeting card finder tool can also be used by store employees (personal shoppers) in a “click-and-collect” scenario, where greeting cards or other merchandise are ordered online and picked up in store. The app can aid the store employees (personal shoppers) in finding the exact location of the greeting card (or other merchandise) ordered by the consumer. The benefits of this feature include making the job of the personal shopper quicker and easier and also eliminating the need for a separate storage or display area required for the card (or other product) being sold in connection with a “click-and-collect” program.

Another feature that may be incorporated into the greeting card finder tool is in-department payment capability. Users may find an appropriate greeting card using the finder functionality, as described above, and then complete the payment transaction through the touch-screen using a credit card or other payment device. Users may also pay for a selected greeting card through the retailer's shopping app.

While the greeting card finder tool has been described herein in connection with the selection and purchase of greeting cards in a greeting card department of a retail store, other products may also be included. Examples include, but are not limited to, gift wrap, bows, tissue paper, gift boxes and stationery. When the user uses the tool to select a greeting card, they system may recommend other items, such as gift wrap, etc. that may be complimentary to the selected greeting card. Users may also receive coupons or product information regarding the non-greeting card merchandise and pay for these items at the touch-screen or in the retailer shopping app as well.

The foregoing embodiments of the present invention have been presented for the purposes of illustration and description. These descriptions and embodiments are not intended to be exhaustive or to limit the invention to the precise form disclosed, and obviously many modifications and variations are possible in light of the above disclosure. The embodiments were chosen and described in order to best explain the principle of the invention and its practical applications to thereby enable others skilled in the art to best utilize the invention in its various embodiments and with various modifications as are suited to the particular use contemplated. It is intended that the invention be defined by the following claims.

1. A greeting card finder tool comprising:
a touch screen device located in a greeting card department of a retail store;
a database containing a plurality of information regarding a plurality of greeting cards for sale at the retail store;
wherein the touch screen engages a user in selecting a greeting card category and an intended recipient and also poses one or more questions to the user to infer the tone of the greeting card; and
wherein after receiving the user's selections and answers to the one or more questions, the touch screen displays a list of appropriate greeting cards for the user to select; and
wherein the touch screen also provides the user with the location of a user selected greeting card.

2. The greeting card finder tool of claim 1, wherein the list of appropriate greeting cards will only contain greeting cards that are in-store at the particular moment the list is created.

3. The greeting card finder tool of claim 1, wherein the tool also enables the user to search for greeting cards using natural language.

4. The greeting card finder tool of claim 1, wherein the tool also enables the user to upload a photo, imagery, or iconography to further define the relationship between the user and the greeting card recipient or to further describe the appropriate greeting card for purchase.

5. The greeting card finder tool of claim 1, wherein the user may deselect one or more of the greeting cards on the list of appropriate greeting cards.

6. The greeting card finder tool of claim 5, wherein in response to a user deselecting one or more greeting cards, the tool will display one or more relevant selections.

7. A process for finding a greeting card in the greeting card department of a retail store including the steps of:
providing software that can interact with a user via a touch screen in a retail store;
displaying a list of greeting card categories or occasions;
receiving from the touch screen the user's selected category or occasion;
displaying a list of recipient categories;
receiving from the touch screen, the user's selected recipient;
displaying one or more questions on the touch screen that will enable to software to more accurately display a list of appropriate greeting cards for the user;
receiving, from the touch screen, the user's selected answers to the one or more questions;
using a quantitative sorting process to determine a list of appropriate greeting cards for the user and displaying said list on the touch screen;
receiving, from the touch screen, the user's selected greeting card;
using the greeting card stock keeping unit (SKU) to locate the card in the retail store and displaying the location to the user on the touch screen.

8. The process of claim 7 including the additional step of receiving uploaded data from the user to further infer the proper tone for the greeting card.

9. The process of claim 7, wherein the software may also guide the user to the exact place in the retail store to find the selected greeting card.

10. The process of claim 7, wherein the software may guide the user by displaying an aisle and row number of where the selected greeting card is located.

11. The process of claim 7, wherein the software may guide the user using Augmented Reality.

12. The process of claim 7, wherein the software may be installed or accessed in/by an in-store kiosk or the user's mobile device.

13. The process of claim 7, wherein the one or more questions posed to the user may include one or more of the following categories: age of the user; age of the recipient; gender of the user; gender of the recipient; relationship between the user and the recipient.

14. The process of claim 7, wherein the software may also allow the user to upload a photo, imagery, or iconography to further refine the list of appropriate greeting cards selected for the user.

15. A greeting card finder tool comprising:
software accessed by a touch screen on an in-store kiosk or a user's mobile device while in a retail store;
a database containing a plurality of information about all greeting cards available for sale in the retail store at the time the user is engaging with the software;
means for displaying output and receiving input from the user, via the touch screen, relating to, at least, the greeting card category, the greeting card recipient, the desired tone of the greeting card;
means to use the received user input to display, on the touch screen, a list of appropriate greeting cards;
wherein the user may select, via the touchscreen, one of the greeting cards from the list; and
wherein the touch screen will display the exact location at which the user may find the selected greeting card.

16. The greeting card finder tool of claim 15, wherein user may also have the option to deselected one or more of the greeting cards contained on the list of appropriate greeting cards that are the least like the greeting card they are looking for.

17. The greeting card finder tool of claim 16, wherein the deselected greeting cards are replaced on the touch screen with new, more appropriate greeting card selections.

18. The greeting card finder tool of claim 15, wherein the user may also enter they type of greeting card they are looking for using natural language.

19. The greeting card finder tool of claim 18, wherein a machine learning algorithm uses the user's natural language input to create and display a list of appropriate greeting cards.

20. The greeting card finder tool of claim 15, wherein the user may enter photos, imagery, or iconography to further define the type of greeting card that he/she is looking for.
